(19) United States
(12) Patent Application Publication
(10) Pub. No.: US 2013/0340845 A1
(43) Pub. Date: Dec. 26, 2013

(54) HIGH-PRESSURE CLEANING APPLIANCE

(71) Applicant: Alfred Karcher GmbH & Co. KG, Winnenden (DE)

(72) Inventors: David Ruckwied, Asperg (DE); Alexandra Schwarz, Spiegelberg (DE); Christoph Breuer, Fellbach (DE); Bernd Kassulat, Kernen (DE)

(73) Assignee: Alfred Karcher GmbH & Co. KG, Winnenden (DE)

(21) Appl. No.: 14/010,111

(22) Filed: Aug. 26, 2013

Related U.S. Application Data
(63) Continuation of application No. PCT/EP2011/053404, filed on Mar. 7, 2011.

(51) Int. Cl. B08B 3/02

(52) U.S. Cl. CPC B08B 3/02
USPC 137/334

(57) ABSTRACT

A high-pressure cleaning appliance is provided, including a heatable heat exchanger for heating a fluid that can be dispensed by the high-pressure cleaning appliance, a motor having a drive shaft that defines a drive axis, a pump unit, a fan for generating a combustion air stream and having a fan housing, and a fuel pump. The high-pressure cleaning appliance includes a first securing device having at least one securing element and a securing element receptacle integrally formed on the fan housing and associated with the at least one securing element, and the first securing device can be transferred from an unsecured position, in which the fuel pump can be coupled to the drive shaft and released from it, to a secured position by inserting the at least one securing element into the securing element receptacle to prevent the fuel pump from being released from the drive shaft.

### CROSS-REFERENCE TO RELATED APPLICATIONS

This application is a continuation of international application number PCT/EP2011/053404, filed on Mar. 7, 2011, which is incorporated herein by reference in its entirety and for all purposes.

### FIELD OF THE INVENTION

The present invention relates to a high-pressure cleaning appliance, comprising a heatable heat exchanger for heating a fluid that can be dispensed by the high-pressure cleaning appliance, a motor having a drive shaft that defines a drive axis, a pump unit for increasing the fluid pressure, a fan for generating a combustion air stream and having a fan housing, and a fuel pump for delivering a fuel for the heat exchanger, the pump unit, the fan and the fuel pump being located along the drive axis and being drivable by the drive shaft, and the high-pressure cleaning appliance comprising at least one securing device for securing the fuel pump on the fan housing on the side thereof facing away from the motor.

### BACKGROUND OF THE INVENTION

In such a high-pressure cleaning appliance as that described, for example, in DE 30 01 571 C2, the pump unit, the motor, the fan and the fuel pump form a motor-pump unit, which has a simple construction and can be manufactured inexpensively and in a compact design. The drive shaft of the motor drives the pump unit on one side of the motor, and drives the fan on the side of the motor opposite from the pump unit. The fuel pump, which can likewise be driven by the drive shaft, is located on the motor pump unit at the end, on the side of the fan facing away from the motor. This makes it possible to use an inexpensive fuel pump without a continuous shaft, which is coupled axially to the drive shaft and secured on the fan housing.

In a high-pressure cleaning appliance of the type stated in the introduction, the fan housing is manufactured from a molded plastics part, for example, having a metal sleeve to secure the fuel pump, the sleeve being molded into the molded part. A retaining protrusion on the fuel pump can be positioned in the sleeve and secured therein by means of screws. This has proven to be reliable for securing the fuel pump, but it requires a substantial manufacturing and assembly effort. If the material of the fan housing is to be recycled, this also results in additional effort for detaching the sleeve from the fan housing.

An object underlying the present invention is to improve upon a generic high-pressure cleaning appliance so that it can be assembled more easily and less expensively.

### SUMMARY OF THE INVENTION

In an aspect of the invention, a high-pressure cleaning appliance comprises a heatable heat exchanger for heating a fluid that can be dispensed by the high-pressure cleaning appliance, a motor having a drive shaft that defines a drive axis, a pump unit for increasing the fluid pressure, a fan for generating a combustion air stream and having a fan housing, and a fuel pump for delivering a fuel for the heat exchanger. The pump unit, the fan and the fuel pump are located along the drive axis and are drivable by the drive shaft, and the high-pressure cleaning appliance comprises at least one securing device for securing the fuel pump on the fan housing on the side thereof facing away from the motor. The high-pressure cleaning appliance has a first securing device having at least one securing element, and has a securing element receptacle, which is associated with the at least one securing element and is integrally formed on the fan housing, and that the first securing device can be transferred from an unsecured position, in which the fuel pump can be coupled to the drive shaft and released from it, to a secured position in which the at least one securing element is located in the securing element receptacle and secures the fuel pump to prevent it from being released from the drive shaft, and the first securing device can be moved into the secured position by inserting the at least one securing element into the securing element receptacle.

### BRIEF DESCRIPTION OF THE DRAWING FIGURES

The foregoing summary and the following description may be better understood in conjunction with the drawing figures:

FIG. 1 shows a side view of a high-pressure cleaning appliance in accordance with the invention, comprising a hood in a slightly open position;

FIG. 2 shows a perspective illustration of a motor pump unit of the high-pressure cleaning appliance from FIG. 1, having a motor, a pump unit, a fan and a fuel pump;

FIG. 3 shows a perspective partial view of the fan and the fuel pump of the motor pump unit from FIG. 2 and a first securing device for securing the fuel pump on the fan, in an exploded illustration;

FIG. 4 shows a perspective illustration of the securing device shown in FIG. 3;

FIG. 5 shows a sectional view of the fuel pump in the state in which it is secured on the fan by the first securing device;

FIG. 6 shows a sectional view along the line 6-6 in FIG. 5, and

FIG. 7 shows a sectional view along the line 7-7 in FIG. 5.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

The present invention relates to a high-pressure cleaning appliance, comprising a heatable heat exchanger for heating a fluid that can be dispensed by the high-pressure cleaning appliance, a motor having a drive shaft that defines a drive axis, a pump unit for increasing the fluid pressure, a fan for generating a combustion air stream and having a fan housing, and a fuel pump for delivering a fuel for the heat exchanger, the pump unit, the fan and the fuel pump being located along the drive axis and being drivable by the drive shaft, and the high-pressure cleaning appliance comprising at least one securing device for securing the fuel pump on the fan housing on the side thereof facing away from the motor. The high-pressure cleaning appliance has a first securing device having at least one securing element, and has a securing element receptacle, which is associated with the at least one securing element and is integrally formed on the fan housing, and that the first securing device can be transferred from an unsecured position, in which the fuel pump can be coupled to the drive shaft and released from it, to a secured position in which the at least one securing element is located in the securing element receptacle and secures the fuel pump to prevent it from being released from the drive shaft, and the first securing device can be moved into the secured position by inserting the at least one securing element into the securing element receptacle.

In the case of the high-pressure cleaning appliance in accordance with the invention, simple and at the same time inexpensive assembly can be achieved by the fact that the first securing device for securing the fuel pump to the drive shaft can be inserted by way of the at least one securing element into the securing element receptacle. For example, the at least one securing element may be pushed into the securing element receptacle. This makes it possible to secure the fuel pump to the fan housing with only minor assembly effort. The first securing device may advantageously be moved to the secured position without the use of a tool in order to thereby facilitate its handling and to secure the fuel pump to the fan housing without the use of a tool. In particular, it is not necessary to screw the fuel pump to the fan housing or to a part thereof.

Furthermore, the securing element receptacle is integrally formed on the fan housing, which for this purpose is or comprises an integrally formed plastics part, for example a housing cover. By integral molding of the securing element receptacle on the fan housing, it is possible first of all to reduce the manufacturing cost of the motor pump unit and to eliminate one work step, which is required with the conventional high-pressure cleaning appliance described above for molding the sleeve into the fan housing. This also facilitates the recycling of the fan housing.

When the fuel pump is connected to the drive shaft and the first securing device is in the secured position, cooperating stop members on the fuel pump, for example the retaining protrusion, and on the at least one securing element on the one hand and on the at least one securing element and on the securing element receptacle on the other hand, may cooperate in securing the fuel pump against axial movement in the direction away from the fan. Similarly, it is possible to provide that stop members of the securing element receptacle and of the at least one securing element on the one hand and of the at least one securing element and the fuel pump, such as the retaining protrusion, on the other hand, cooperate to secure the fuel pump against axial movement in the direction of the fan. This makes it possible to ensure an especially well-defined relative positioning of the fuel pump on the motor pump unit when the first securing device is in the secured position.

It is advantageous if the at least one securing element is located in the securing element receptacle in a positively-locking or substantially positively-locking manner in the secured position of the first securing device in the axial direction and/or in a direction oriented transversely with respect to the drive axis. This permits reliable seating of the first securing device on the fan housing when it is in the secured position, and thereby allows reliable securing of the fuel pump to the fan housing. For positively-locking or substantially positively-locking seating of the at least one securing element transverse to the drive axis, stop members that act transversely with respect to the drive axis are provided on the securing element and on the securing element receptacle.

The fuel pump preferably comprises at least one securing recess with which the at least one securing element engages in a positively-locking or substantially positively-locking manner in the axial direction in the secured position of the first securing device. Therefore, the first securing device in the secured position and the fuel pump both assume especially well-defined positions in relation to one another to reliably secure the fuel pump to the fan housing. The at least one securing recess is a groove, for example, whose walls form stop members for the at least one securing element engaging in the groove, to prevent axial movement of the fuel pump.

The first securing device may comprise more than just one securing element, for example, two securing elements.

It is advantageous if the first securing device comprises two securing elements which jointly engage around the fuel pump in the secured position of the first securing device in a positively-locking or substantially positively-locking manner transverse to the drive axis. The two securing elements may accommodate the fuel pump in a positively-locking or substantially positively-locking manner between them. This makes it possible to prevent a movement of the fuel pump transverse to the axial direction. The fuel pump may therefore also be secured transversely with respect to the drive axis in an especially well-defined relative position with the fan housing.

The at least one securing element can preferably be inserted, in particular pushed, into the securing element receptacle, transversely with respect to the drive axis. Transverse to the insertion direction and/or along the drive axis, the at least one securing element is preferably located in the securing element receptacle in a positively-locking manner, as mentioned above.

It is advantageous if the first securing device comprises or forms at least one handle element for gripping by the user. This makes it easier for a user to handle the first securing device.

The high-pressure cleaning appliance preferably comprises a guide device having at least one guide element for guiding the first securing device when it is transferred from the unsecured position to the secured position. This makes it easier for the user to mount the fuel pump on the fan housing. The first securing device may be placed on the at least one guide element and may be guided by it into the secured position, for example by pushing the at least one securing element into the securing element receptacle.

The guide device is advantageously located outside of the securing element receptacle. This makes it possible to guide the first securing device even when the at least one securing element is not yet located in the securing element receptacle, not even partially.

The at least one guide element is preferably integrally formed on the fan housing. This makes it possible to impart a simple structural design to the motor pump unit.

For example, the at least one guide element is a guide rib which is integrally formed in particular on the fan housing and along which the first securing device can be displaced to slide the at least one securing element into the securing element receptacle.

It is advantageous if the high-pressure cleaning appliance comprises a stop element for limiting the movement of the first securing device in transferring it from the unsecured position into the secured position. When the first securing device contacts the stop element, it is signaled to the user that the first securing device is in the secured position. This makes it easier for the user to install the motor pump unit, and makes it possible to ensure the correct positioning of the first securing device in relation to the fan housing.

The fan housing advantageously comprises the stop element, which is especially preferably integrally formed on the fan housing. This permits a structurally simple configuration of the motor pump unit.

It is advantageous if the high-pressure cleaning appliance comprises a locking device which, in a locked position, secures the first securing device in the secured position to prevent it from being moved into the unsecured position. This ensures that the fuel pump is not released inadvertently from the drive shaft, which in turn ensures reliable functioning of the motor pump unit.

It is advantageous if the locking device comprises locking elements, integrally formed on the first securing device and/or on the fan housing, which cooperate to lock the securing device. This makes it possible to impart a structurally simple design to the motor pump unit.

In an advantageous embodiment of the high-pressure cleaning appliance, the locking device may be a detent device in particular. In combination with the latter-described embodiment above, it is provided in particular that the first securing device latches with the fan housing in the locked position.

The high-pressure cleaning appliance preferably comprises an actuating device for transferring the locking device from the locked position into an unlocked position in which the first securing device can be transferred from the secured position to the unsecured position. The actuating device, which can preferably be operated without the use of tools, makes it possible for the user to move the locking device to the unlocked position in an easy-to-handle manner This allows a transfer of the first securing device to the unsecured position to release the fuel pump from the motor pump unit. The first securing device can preferably be moved to the unsecured position without the use of tools.

For example, the locking device is moved to the unlocked position by discontinuing the detent engagement of the first securing device with the fan housing.

In an embodiment of the motor pump unit having a simple design, it is advantageous if the actuating device comprises at least one actuating element that is integrally formed on the first securing device.

It is possible to provide for the first securing device to be at least partially elastically deformable. For example, the locking element mentioned above may be elastically deformable so that it can be disengaged from the fan housing by using the actuating device, for example.

In particular in the latter-mentioned case, it is advantageous if the actuating device comprises at least one limiting element for limiting the movement of the locking device, for example, of the locking element of the first securing device, during transfer from the locked position into the unlocked position. The limiting device ensures that the locking device is not damaged in the transfer to the locked position.

The first securing device is preferably formed in one piece, since this allows a structurally simply design and inexpensive production of the motor pump unit. In particular the at least one securing element, at least one locking element, at least one actuating element and at least one limiting element may be connected to one another in one piece.

In a practical implementation of the high-pressure cleaning appliance in accordance with the invention, for a structurally simple configuration it has proven advantageous if the first securing device is configured as a securing clip having a leg which forms the at least one securing element, preferably two legs spaced a distance apart, each forming a securing element and connected to one another by a bridge. The securing clip may be formed in one piece and preferably comprises two legs, each forming a securing element and accommodating the fuel pump in a positively-locking manner or a substantially positively-locking manner between the two legs in the secured position. They engage in a positively-locking or substantially positively-locking manner in a groove-type securing receptacle, for example, which is formed on the fuel pump. In an extension of the respective leg beyond the bridge, the securing clip may have additional elastically deformable leg-shaped projecting parts which form locking elements for detent engagement with the fan housing. On the projecting parts that form the locking elements, actuating elements in the form of protrusions may be provided by means of which the locking elements can be deformed to bring the securing clips out of engagement with the fan housing and to discontinue the detent engagement. Protruding limiting elements of the securing clips may limit the deformation of the locking elements. Furthermore, a handle element may be integrally formed on the securing clip so that the securing clip can be easier for the user to handle.

It is advantageous if the high-pressure cleaning appliance comprises a second securing device having at least one antitwist element which cooperates with the fuel pump to secure same against rotation about the drive axis. In addition to the first securing device, the high-pressure cleaning appliance may comprise the second securing device. The at least one antitwist element exerts a reaction torque on the fuel pump in the direction opposite to the motor torque to secure the fuel pump against rotation about the drive axis.

A structurally simple and effective means of securing the fuel pump may be achieved, for example, by the fact that the at least one antitwist element is in face-to-face contact with the fuel pump so that the largest possible area of interaction is present between the antitwist element and the fuel pump.

The at least one antitwist element is preferably a protrusion on the fan housing that can be placed face-to-face on the fuel pump housing to achieve the above-mentioned advantage in the simplest possible manner.

It is advantageous if the second securing device comprises two protrusions that can be placed face-to-face against two side walls of the housing which are oriented transversely with respect to one another. The two antitwist elements in the form of protrusions may be adjacent to one another at a common edge, for example. First of all, this allows the fuel pump to be reliably secured against twisting about the drive axis, and secondly, it permits the fuel pump and the fan housing to be positioned in a defined manner in relation to one another.

The at least one antitwist element is preferably integrally formed on the fan housing. This permits a structurally simple configuration of the motor pump unit. For example, the antitwist element is a rib integrally formed on the fan housing or an orientation angle having two contact faces oriented transversely with respect to one another for the housing of the fuel pump.

It is advantageous if the fan housing comprises or forms a contact flange for the fuel pump. In this way, the fuel pump may be brought into a clearly defined position in relation to the fan housing. The contact flange is advantageously oriented at a right angle to the drive axis.

It is advantageous if a central opening is formed on the contact flange, through which the fuel pump engages partially in the fan housing in the state in which it is coupled to the drive shaft, and if the portion of the fuel pump that engages in the fan housing can be secured on the fan housing by the first securing device taking up the secured position. The fuel pump may contact the contact flange with a housing, for example, and may engage partially in the fan housing and may be secured thereon by the retaining protrusion mentioned above.

In particular in the latter-described embodiment, it is advantageous if the securing element receptacle is located on a rear side of the contact flange in the fan housing. For example, the fan housing comprises a housing wall, which forms the contact flange on the outside and forms a stop member on the inside on which the at least one securing element can be supported to secure the fuel pump against axial movement.

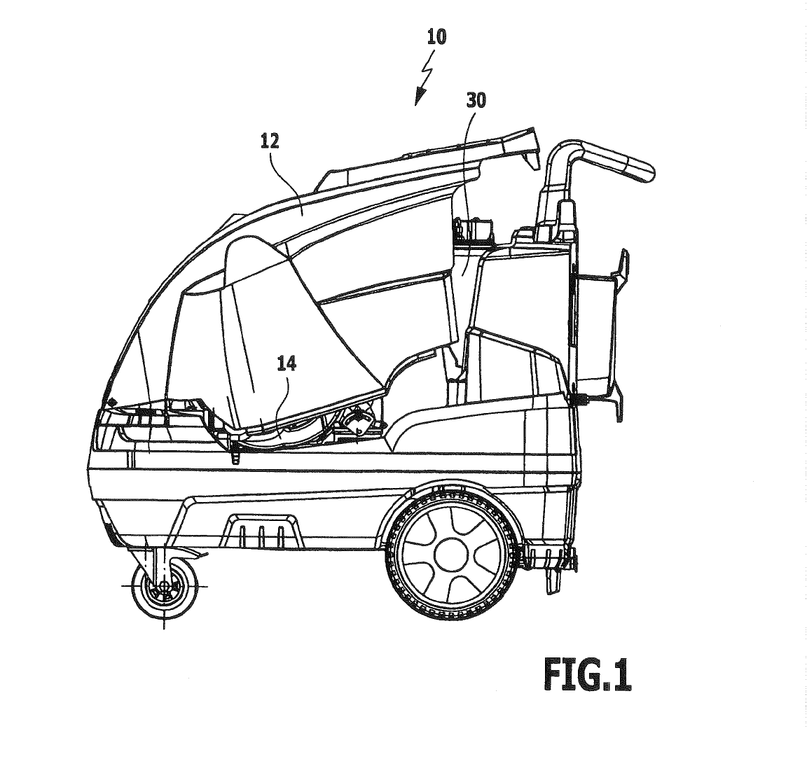

FIG. 1 shows in a side view a preferred embodiment of a high-pressure cleaning appliance in accordance with the invention, denoted by reference numeral 10. The high-pressure cleaning appliance 10 comprises a hood 12, which is shown in a slightly open position in FIG. 1 and partially enables a view of a fan 14 of the high-pressure cleaning appliance.

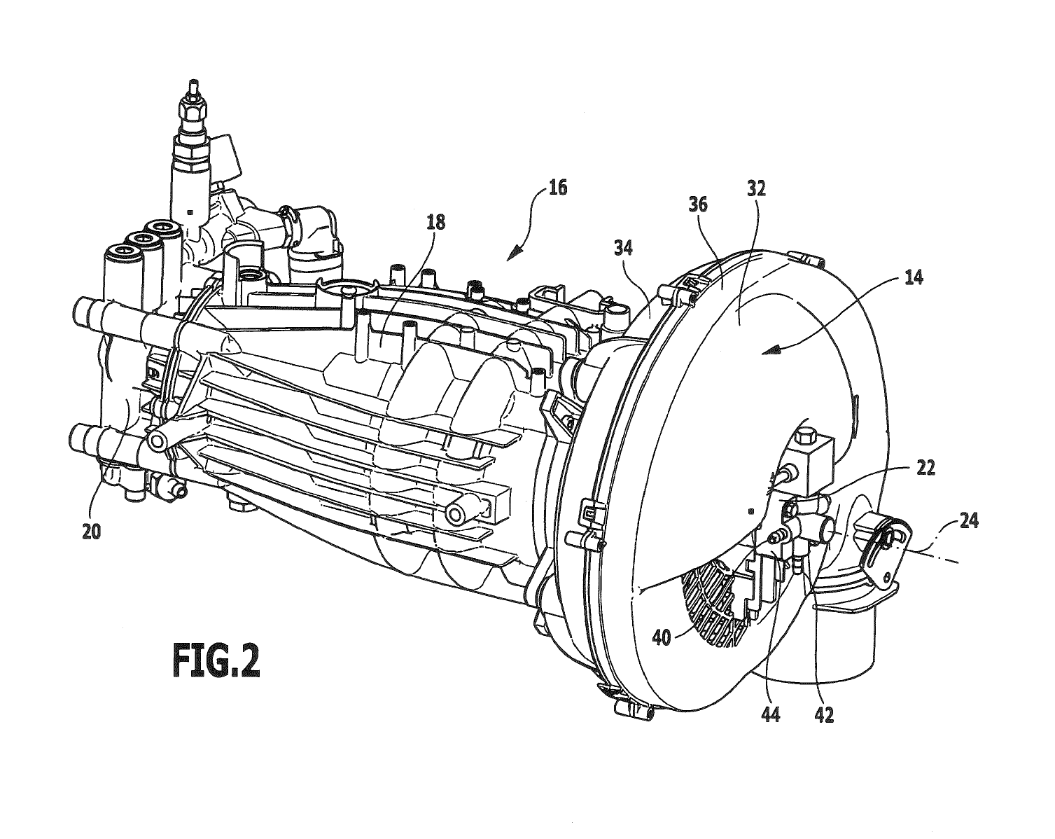

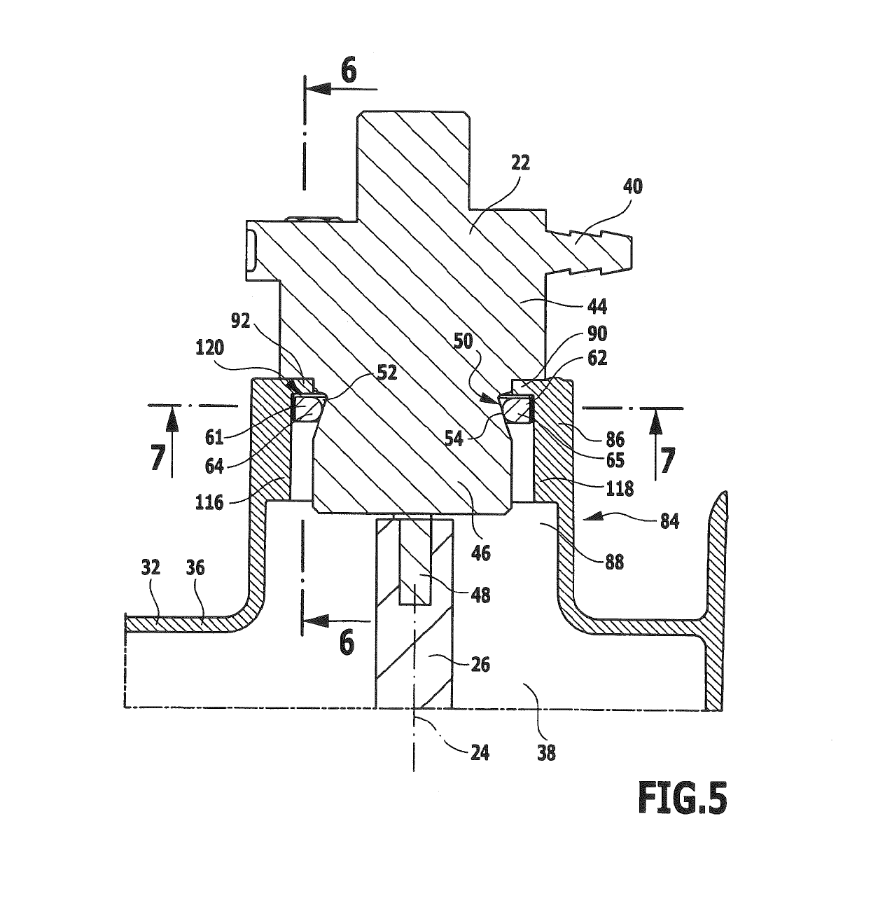

The fan 14 is part of a motor pump unit, shown in a perspective view in FIG. 2, comprising a motor 18, a pump unit 20, the fan 14 and a fuel pump 22. The motor pump unit 16 has a linear design along a drive axis 24, which is defined by a drive shaft 26 of the motor 18, a portion of which is shown in FIG. 5. The drive shaft 26 serves to drive the pump unit 20, the fan 14 and the fuel pump 22.

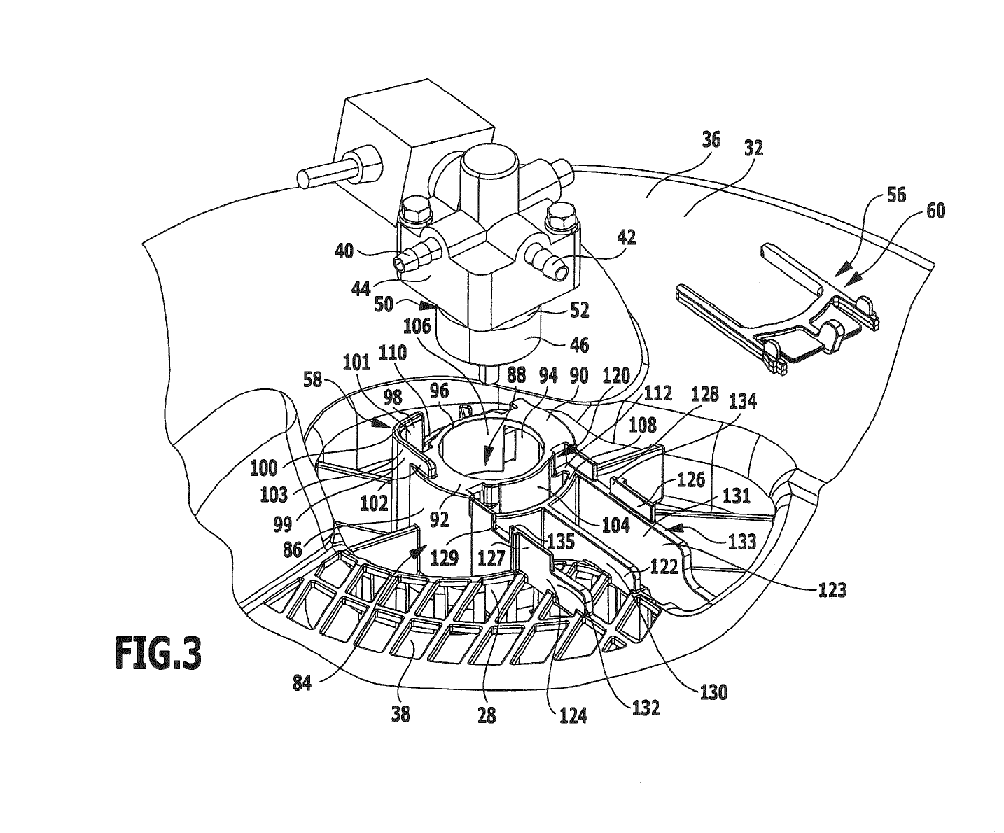

The pump unit 20 is located at the end on the motor pump unit 16 to pressurize a liquid that can be dispensed by the high-pressure cleaning appliance 10. The fan 14 is located on the side of the motor 18 opposite from the pump unit 20. The fan 14 has a fan wheel 28, a portion of which is shown in FIG. 3. A combustion air stream can be generated by means of the fan wheel 28 and is supplied to a heat exchanger 30 (shown in FIG. 1) of the high-pressure cleaning appliance 10. The heat exchanger 30 comprises a burner (not shown in the drawing), so that cleaning fluid pressurized in the heat exchanger 30 by the pump unit 20 can be heated to increase its cleaning effect.

The fan 14 comprises a fan housing 32 having a housing base 34 which is secured to the motor 18, by a screw connection, for example. A housing cover 36 is fitted on the housing base 34 on the side facing away from the motor 18, and the fan wheel 28, which is fitted on the drive shaft 26 in a rotationally fixed manner, is accommodated in a housing interior 38, which is enclosed by the housing base 34 and the housing cover 36. The housing base 34 and the housing cover 36 are each manufactured in one piece.

The fuel pump 22 is located on the end of the motor pump unit 16 opposite from the pump unit 20. The fuel pump 22 serves to supply fuel to the burner in the heat exchanger 30. The fuel is stored in a fuel storage tank (not shown in the drawing) of the high-pressure cleaning appliance 10. This fuel can be supplied to the fuel pump 22 via fuel lines (likewise not shown in the drawing), and can be delivered by the fuel pump to the burner in the heat exchanger 30.

For connecting the fuel lines, the fuel pump 22 has two connections 40 and 42 on a cube-shaped pump housing 44. A cylindrical retaining protrusion 46 protrudes axially away from the pump housing 44. In the installed state of the fuel pump 22, this protrusion engages into the housing interior 38, as will be discussed further below, and is secured on the fan housing 32. A shaft 48 of the fuel pump 22 protrudes axially away from the retaining protrusion 46 in the direction of the fan wheel 28. The shaft 48 is connected to the end of the drive shaft 26 of the motor 18 in a rotationally fixed manner (FIG. 5).

The retaining protrusion 46 has a securing receptacle 50 on its portion adjacent to the pump housing 44. The securing receptacle 50 is configured as a ring groove 52 which defines a plane perpendicular to the drive axis 24. The ring groove 52 comprises a groove wall 54, which tapers conically in the direction of the pump housing 44 with respect to the drive axis 24, said groove wall forming a peripheral stop member for securing the fuel pump 22 to the fan housing 32.

To secure the fuel pump 22 in the intended position on the fan housing 32 as illustrated in FIG. 2, the high-pressure cleaning appliance 10 has a first securing device 56 and a second securing device 58. The first securing device 56 is provided for securing the fuel pump 22 to prevent it from coming loose from the drive shaft 26 in the axial direction. The second securing device 58 serves as a twist-preventing device for the fuel pump 22 in order to counteract the torque of the motor and secure the fuel pump 22 to prevent it from rotating about the drive axis 24 in relation to the fan 14.

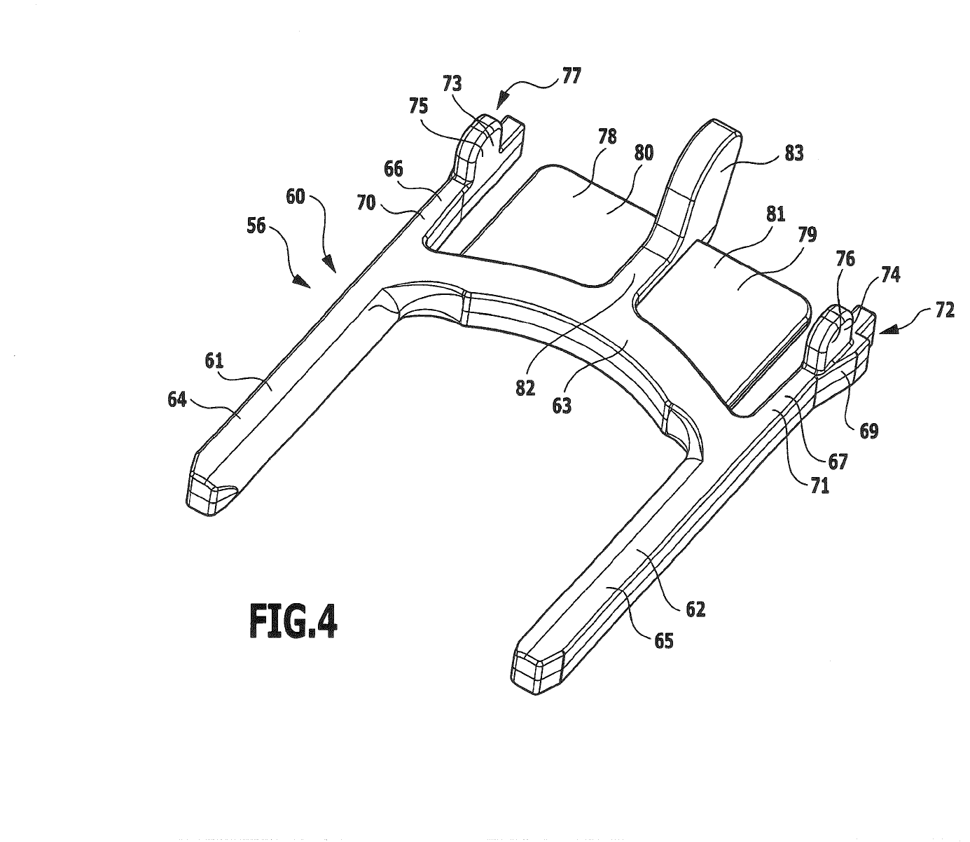

The first securing device 56, which is shown in a perspective view in FIG. 4, is configured as a securing clip 60 having two legs 61 and 62 which are located parallel to one another and are connected to one another by a curved bridge 63. The legs 61 and 62 form securing elements 64 and 65, respectively, for axially securing the fuel pump 22, as will be discussed further below.

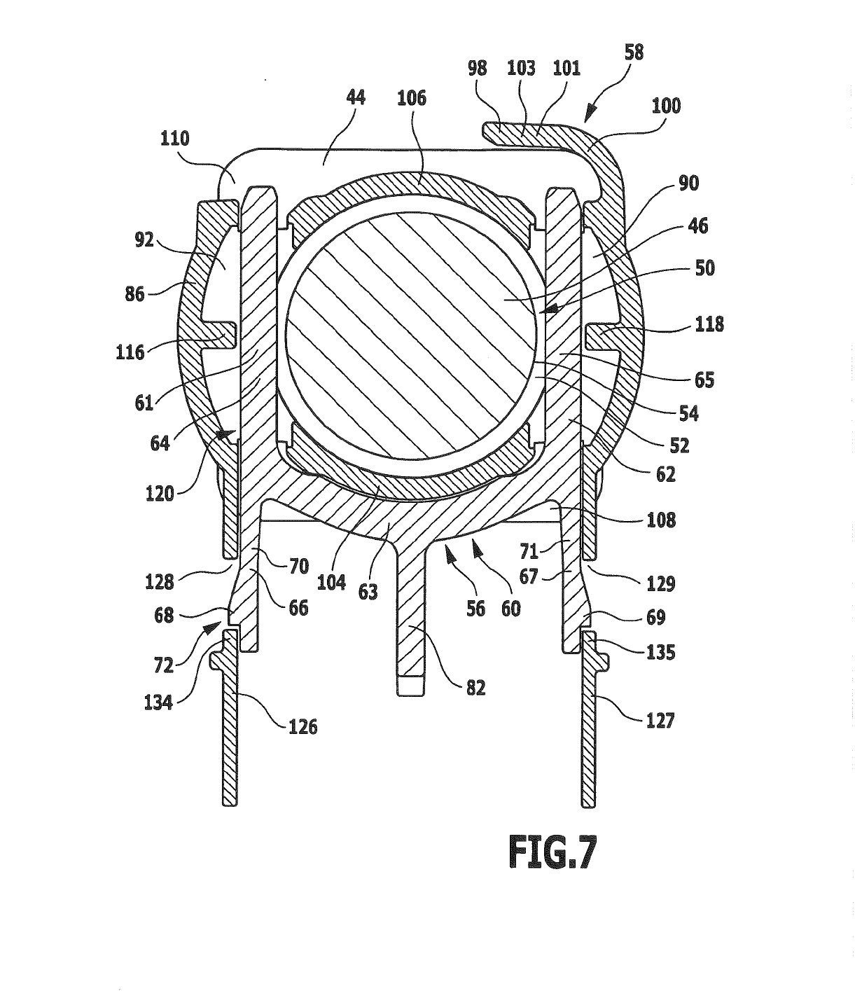

In an extension of the legs 61 and 62 beyond the bridge 63, the securing clip 60 has leg-shaped extensions 66 and 67. Detent protrusions 68 and 69 are located on the extensions 66 and 67, respectively, on the side facing away from the respective other extension 66, 67 (FIGS. 4 and 7). The extensions 66 and 67 having the detent protrusions 68 and 69 form locking elements 70 and 71, respectively, of a locking device 72 for releasable locking of the securing clip 60 to the housing cover 36. The extensions 66 and 67 can be moved toward one another by elastic deformation of the securing clip 60, the extensions 66 and 67 being able to undergo elastic deformation where they join the bridge 63.

The securing clip 60 has protrusions 73 and 74 to facilitate deformation of the extensions 66 and 67, respectively. The protrusions 73 and 74 are next to the detent protrusions 68 and 69 on the extensions 66 and 67, and protrude out of the plane defined by the legs 61, 62, the bridge 63, and the extensions 66 and 67. The protrusions 73 and 74 are actuating elements 75 and 76, respectively, of an actuating device 77 for actuating the locking device 72.

When the protrusions 73 and 74 are acted upon by mutually directed forces, the extensions 66 and 67, respectively, undergo elastic deformation. To prevent damage to them, the securing clip 60 comprises limiting elements 78 and 79 for limiting the extent to which the extensions 66 and 67 are deformed. The limiting elements 78 and 79 are configured as wings 80 and 81, respectively, extending outward from the bridge 63.

The wings 80 and 81 are integrally formed on a web 82 which is located between them and which extends away from the bridge 63, a handle element 83 being integrally formed on the end thereof facing away from the bridge 63. The handle element 83 is provided to facilitate handling of the securing clip 60 by the user.

The securing clip 60 is formed in one piece overall.

As can be seen in FIGS. 3 and 5 through 7, the one-piece housing cover 36 comprises a tower-shaped fixing portion 84 for fixing the fuel pump 22 on the fan 14. The fixing portion 84 has a cylindrical outside wall 86 which is aligned coaxially with the drive axis 24. The outside wall 86 encloses a receiving space 88, which forms a part of the housing interior 38.

In addition, the fixing portion 84 at the end comprises a supporting wall 90 oriented at a right angle to the drive axis 24. The supporting wall 90 forms a contact flange 92 for the pump housing 44 of the fuel pump 22. The supporting wall 90 has a central opening 94 which is encompassed by an edge 96. The fuel pump 22 can be inserted partially into the receiving space 88 through the opening 94, namely, via the cylindrical retaining protrusion 46. When the pump housing 44 is in contact with the contact flange 92, the retaining protrusion 46 extends sufficiently far into the receiving space 88 for the shaft 48 to couple to the drive shaft 26.

The second securing device 58 already mentioned above comprises two antitwist protection elements 98 and 99 which extend away from the outside wall 86 and the supporting wall 90, respectively, parallel to the drive axis 24. The antitwist protection elements 98 and 99 are ribs 101 and 102, respectively, which are connected to one another in one piece at a rounded edge 100, together forming an angle bracket 103. The angle bracket 103 projects from the plane defined by the contact flange 92, and is dimensioned such that it can lie face-to-face on two side walls of the pump housing 44 oriented transversely with respect to one another (FIG. 7).

When the shaft 48 of the fuel pump 22 is driven by the drive shaft 26, the angle bracket 103 forms an antitwist protection so that the fuel pump 22 does not rotate in relation to the fan 14. In addition, the angle bracket 103 facilitates the orientation of the fuel pump 22 in relation to the fan 14 during assembly. When the pump housing 44 is in contact with the contact flange 92 and with the angle bracket 103, the fuel pump 22 takes up its desired position on the fan 14 and can be secured in the axial direction by means of the securing clip 60.

Two curved inside wall segments 104 and 106 which are opposite one another with respect to the drive axis 24 protrude away from the edge 96 of the opening 94 into the receiving space 88. The inside wall segments 104 and 106, which are parallel to the drive axis 24, are approximately as long as the retaining protrusion 46 of the fuel pump 22. The inside wall segments 104 and 106 may be regarded as deriving from a cylindrical inside wall aligned coaxially with the drive axis 24, from which two portions opposite one another are cut off (FIGS. 3 and 7).

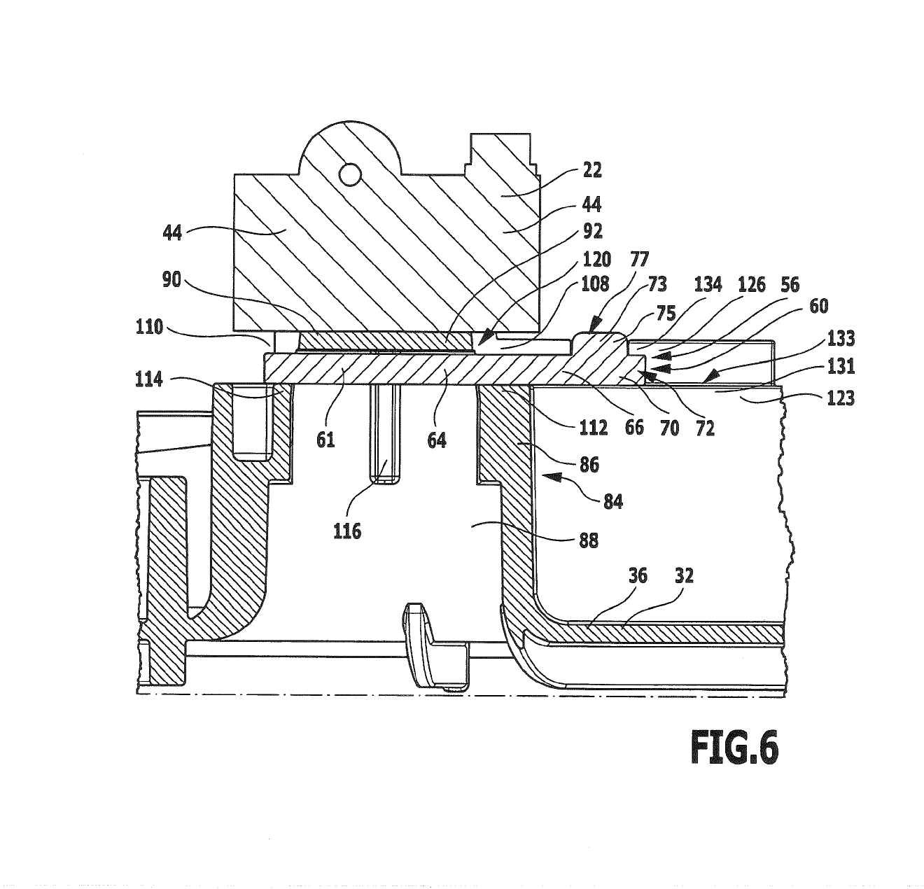

The outside wall 86 has recesses 108 and 110 radially outside the inside wall segments 104 and 106, respectively (FIGS. 3 and 6). The outside wall 86 therefore does not extend up to the supporting wall 90, which is bordered by the edge 96 in the circumferential direction, in the circumferential region of the inside wall segments 104 and 106. Parallel to the drive axis 24, the recesses 108 and 110 are somewhat shorter than the inside wall segments 104 and 106. The outside wall 86 and the inside wall segments 104 and 106 are connected to one another by means of four shoulders oriented at a right angle to the drive axis 24 at the side edges of the recesses 108 and 106. Of the four shoulders, only two shoulders 112 and 114 can be seen in the drawings in FIGS. 3 and 6. Corresponding shoulders are also located on the fixing portion 84 adjoining the ends of the inside wall segments 104 and 106 which are opposite from the ends of the inside wall segments 104 and 106 at which the shoulders 112 and 114 are located.

Rib-shaped protrusions 116 and 118 extend away from the outside wall 86, in each case protruding axially as far as the inside wall segments 104 and 106 and extending radially into the receiving space 88. The protrusions 116 and 118 are located opposite one another with respect to the drive axis 24, and are located approximately between the shoulders 112 and 114 or the shoulders that are not shown in the drawings.

Overall, there is therefore a securing element receptacle 120 for the legs 61 and 62 of the securing clip 60 between the inside of the supporting wall 90 facing the receiving space 88, the shoulders 112 and 114, as well as the shoulders of the outside wall 86 which are not shown in the drawings, and the inside wall segments 104 and 106.

In the region of the recess 108, ribs 122, 123 and 124 protrude outwardly from the outside wall 86. The rib 122 is oriented radially with respect to the drive axis 24, and the ribs 123 and 124 run on opposite sides of the rib 122 and are aligned parallel to this rib. The top sides of the ribs 122 to 124 are located in the plane defined by the shoulders 112 and 114 as well as the shoulders that are not shown, and by the outside wall 86 in the region of the recess 108.

Additional ribs 126 and 127, whose wall thicknesses are each somewhat smaller than those of the ribs 123 and 124, respectively, extend away from the ribs 123 and 124, parallel with the drive axis 24. The ribs 126 and 127 are interrupted at recesses 128 and 129, respectively.

The ribs 122, 123 and 124 are guide elements 130, 131 and 132, respectively, which jointly form a guide device 133 for the securing clip 60.

The ribs 126 and 127 form locking elements 134 and 135, respectively, of the locking device 72, and can cooperate with the detent protrusions 68 and 69, respectively, for detent engagement of the securing clip 60.

The fuel pump 22 may be secured, for example, as follows by means of the securing clip 60.

The fuel pump 22 is first to be placed against the contact flange 92, as described above. The fuel pump may be aligned by means of the angle bracket 103. The retaining protrusion 46 engages far enough into the receiving space 88 that the ring groove 52 is located centrally, based on a longitudinal direction of the drive axis 24, between the supporting wall 90 and the shoulders 112 and 114 as well as the shoulders not shown. The shaft 48 couples to the drive shaft 26.

The securing clip 60 is in an unsecured position in which the fuel pump 22 can be released axially from the drive shaft 26. For moving to a secured position, the user can grip the securing clip 60 by the handle element 83, and place the leg 61 and the extension 66 onto the rib 123 and place the leg 62 and the extension 67 onto the rib 124. Furthermore, the user can place the web 82 on the central rib 122. Guided by the ribs 122, 123 and 124 and also by the ribs 126 and 127, the user can insert, in particular slide, the securing clip 60 together with the legs 61 and 62 into the securing element receptacle 120 without the use of tools.

The inside wall segment 104 foams a stop element for the bridge 63. When the bridge strikes against the inside wall segment 104, the securing clip 60 assumes a secured position. In the secured position, the leg 61 is located parallel to the drive axis 24 in a positively-locking manner in the securing element receptacle 120, between the shoulders 112 and 114 on the one hand and the supporting wall 90 on the other hand, each forming stop members for the leg 61. Similarly, the leg 62 is located in a positively-locking manner between the shoulders (not shown) and the supporting wall 90.

The legs 61 and 62 together extend around the cylindrical retaining protrusion 46; i.e., they hold the retaining protrusion 46 between them. The two legs 61 and 62 each engage in the ring groove 52 in a positively-locking manner and are supported on the groove wall 54 in the direction of the drive shaft 26 (FIG. 5). The retaining protrusion 46 is thus located in a positively-locking manner between the legs 61 and 62, transversely with respect to the direction of the drive axis 24.

Further, the legs 61 and 62 are seated in the securing element receptacle 120, transversely with respect to the drive axis 24, between the outside wall 86 and the protrusion 116, and the outside wall 86 and the protrusion 118, respectively, on the one hand, and the inside wall segments 104 and 106 on the other hand, in a manner that is virtually free of play (FIG. 7).

When the securing clip 60 is in the secured position, the fuel pump 22 is secured against loosening from the drive shaft 26 in the direction pointing away from the fan 14. The groove wall 54 and the legs 61 and 62 form cooperating stop members, and the legs 61 and 62 and the supporting wall 90 likewise form cooperating stop members to divert a pulling force acting on the fuel pump 22 and away from the fan 14, to the housing cover 36. The purpose of the protrusions 116 and 118 is to prevent the legs 61 and 62 from being spread transversely with respect to the drive axis 24 due to the conical shape of the groove wall 54 when the pulling force acts on the legs 61 and 62.

Furthermore, the locking device 72 assumes a locked position when the securing clip 60 takes up the secured position. In the locked position, the detent protrusions 68 and 69 become locked to the ribs 126 and 127, respectively, in the area of the recesses 128 and 129 (FIG. 7). This secures the securing clip 60 in the secured position to prevent it from being moved to the unsecured position, while at the same time ensuring that the fuel pump 22 is reliably secured to the housing cover 36.

If it is necessary to release the fuel pump 22 from the fan 14, it is possible to proceed as follows. The user can act upon protrusions 73 and 74 with oppositely directed forces, and can transfer the locking device 72 from the locked position into an unlocked position. The unlocked position is assumed when the detent protrusions 68 and 69 become disengaged from the ribs 126 and 127, respectively, namely with the aforementioned deformation of the extensions 66 and 67, respectively. In this case, the wings 80 and 81 ensure that the extensions 66 and 67 do not undergo excessive deformation, possibly resulting in damage to the securing clip 60.

When the locking device 72 is in the unlocked position, the securing clip 60 can be transferred from the secured position into the unsecured position by being displaced along the ribs 122, 123 and 124, transversely with respect to the drive axis 24. This makes it possible to remove the legs 61 and 62 from the securing element receptacle 120. Therefore, at the same time, the engagement present between the legs 61 and 62 and the groove wall 54 is discontinued, so that the fuel pump 22 is no longer secured via the securing clip 60 against axial movement away from the fan 14.

The uncoupling of the securing of the fuel pump 22 against axial movement via the securing clip 60 on the one hand, and against twisting about the drive axis 24 due to the angle bracket 103 on the other hand, permits structurally simple and inexpensive production of the motor pump unit 16, and thus of the high-pressure cleaning appliance 10. Only integrally formed plastics parts that can be manufactured inexpensively and easily are used to secure the fuel pump 22. Furthermore, the fuel pump 22 is secured using only minor assembly effort, in that the legs 61 and 62 of the securing clip 60 are inserted into the securing element receptacle 120. The fuel pump 22 is thereby secured on the housing 36 without the use of tools, and can be installed on the housing cover 36 in only two steps, namely, placement on the contact flange 92 in the correct orientation in relation to the angle bracket 103, and transfer of the securing clip 60 to the secured position without the use of tools, by inserting and in particular pushing the legs 61 and 62 into the securing element receptacle 120.

That which is claimed:

1. A high-pressure cleaning appliance, comprising a heatable heat exchanger for heating a fluid to be dispensed by the high-pressure cleaning appliance, a motor having a drive shaft that defines a drive axis, a pump unit for increasing the fluid pressure, a fan for generating a combustion air stream and having a fan housing, and a fuel pump for delivering a fuel for the heat exchanger, the pump unit, the fan and the fuel pump being located along the drive axis and being drivable by the drive shaft, and the high-pressure cleaning appliance comprising at least one securing device for securing the fuel pump on the fan housing on its side facing away from the motor, wherein the high-pressure cleaning appliance comprises a first securing device having at least one securing element and a securing element receptacle integrally formed on the fan housing and associated with the at least one securing element, and wherein the first securing device is transferable from an unsecured position, in which the fuel pump is coupleable to the drive shaft and releasable from it, to a secured position in which the at least one securing element is located in the securing element receptacle and secures the fuel pump to prevent it from being released from the drive shaft, and the first securing device is movable to the secured position by inserting the at least one securing element into the securing element receptacle.

2. The high-pressure cleaning appliance in accordance with claim 1, wherein the at least one securing element is located in a positively-locking or substantially positively-locking manner in the securing element receptacle in the secured position of the first securing device in at least of the axial direction and a direction oriented transversely with respect to the drive axis.

3. The high-pressure cleaning appliance in accordance with claim 1, wherein the fuel pump comprises at least one securing recess with which the at least one securing element engages in a positively-locking or substantially positively-locking manner in the axial direction in the secured position of the first securing device.

4. The high-pressure cleaning appliance in accordance with claim 1, wherein the first securing device comprises two securing elements which engage around the fuel pump in a positively-locking or substantially positively-locking manner transverse to the drive axis in the secured position of the first securing device.

5. The high-pressure cleaning appliance in accordance with claim 1, wherein the at least one securing element is insertable into the securing element receptacle transversely with respect to the drive axis.

6. The high-pressure cleaning appliance in accordance with claim 1, wherein the first securing device comprises or forms at least one handle element for gripping by the user.

7. The high-pressure cleaning appliance in accordance with claim 1, wherein the high-pressure cleaning appliance comprises a guide device having at least one guide element for guiding the first securing device when it is transferred from the unsecured position into the secured position.

8. The high-pressure cleaning appliance in accordance with claim 7, wherein the at least one guide element is integrally formed on the fan housing.

9. The high-pressure cleaning appliance in accordance with claim 1, wherein the high-pressure cleaning appliance comprises a locking device which, in a locked position, secures the first securing device in the secured position to prevent it from being moved to the unsecured position.

10. The high-pressure cleaning appliance in accordance with claim 9, wherein the locking device comprises cooperating locking elements which are integrally formed on at least one of the first securing device and the fan housing for locking the securing device.

11. The high-pressure cleaning appliance in accordance with claim 9, wherein the high-pressure cleaning appliance comprises an actuating device for transferring the locking device from the locked position into an unlocked position in which the first securing device is transferable from the secured position to the unsecured position.

12. The high-pressure cleaning appliance in accordance with claim 11, wherein the actuating device comprises at least one actuating element that is integrally formed on the first securing device.

13. The high-pressure cleaning appliance in accordance with claim 1, wherein the first securing device is formed in one piece.

14. The high-pressure cleaning appliance in accordance with claim 1, wherein the first securing device is configured as a securing clip having one leg which forms the at least one securing element.

15. The high-pressure cleaning appliance in accordance with claim 14, the securing clip having two legs at a distance apart from one another, each forming a securing element and connected to one another via a bridge.

16. The high-pressure cleaning appliance in accordance with claim 1, wherein the high-pressure cleaning appliance comprises a second securing device having at least one antitwist element which cooperates with the fuel pump to secure same against rotation about the drive axis.

17. The high-pressure cleaning appliance in accordance with claim 16, wherein the at least one antitwist element is a protrusion on the fan housing to be placed in face-to-face contact with a housing of the fuel pump.

18. The high-pressure cleaning appliance in accordance with claim 16, wherein the at least one antitwist element is integrally formed on the fan housing.

19. The high-pressure cleaning appliance in accordance with claim 1, wherein the fan housing comprises or forms a contact flange for the fuel pump.

20. The high-pressure cleaning appliance in accordance with claim 19, wherein a central opening is formed on the contact flange through which the fuel pump engages partially in the fan housing in the state in which it is coupled to the drive shaft, and the portion of the fuel pump engaging in the fan housing is secured on the fan housing by the first securing device taking up the secured position.

21. The high-pressure cleaning appliance in accordance with claim 19, wherein the securing element receptacle is located on a rear side of the contact flange in the fan housing.

22. The high-pressure cleaning appliance in accordance with claim 1, wherein the first securing device is insertable into the securing device receptacle without any tools being used.

23. The high-pressure cleaning appliance in accordance with claim 1, wherein the first securing device is insertable into the securing device receptacle by sliding.

24. The high-pressure cleaning appliance in accordance with claim 1, wherein the secured position of the first securing device, stop members on the fuel pump and on the at least one securing element cooperate and stop members on the at least one securing element and the securing element receptacle cooperate in securing the fuel pump against axial movement in at least one of a direction away from the fan and a direction of the fan.
